(19) United States
(12) Patent Application Publication
(10) Pub. No.: US 2021/0008945 A1
(43) Pub. Date: Jan. 14, 2021

(54) STABILISATION SYSTEM FOR A WHEELED VEHICLE EQUIPPED WITH A LOAD- CARRYING ARM, AND WHEELED VEHICLE EQUIPPED WITH A LOAD-CARRYING ARM, INCLUDING THIS STABILISATION SYSTEM

(71) Applicant: ELIATIS, Moirans (FR)

(72) Inventor: Jean-Luc PERRIN, Voreppe (FR)

(73) Assignee: ELIATIS, Moirans (FR)

(21) Appl. No.: 16/651,638

(22) PCT Filed: Sep. 26, 2018
(86) PCT No.: PCT/EP2018/076194

§ 371 Date: Aug. 19, 2020

(30) Foreign Application Priority Data
Sep. 27, 2017 (FR) 1758975

(51) Int. Cl. B60G 17/0165; B60G 9/02

(52) U.S. Cl. CPC B60G 17/0165; A01D 42/00; B60G 9/02

(57) ABSTRACT

The system includes an oscillating chassis (10) suitable for being linked to an axle (6) of a vehicle (1); two cylinders (11, 12), referred to as “compensation cylinders”, linking the oscillating chassis (10) to the main chassis (5) of the vehicle; a proportional distributor or valve (13) to which the compensation cylinders (11, 12) are connected; an axle tilt detector (14) detecting tilt of the axle (6) resulting in the wheel (2) of the vehicle (I) opposite the arm (3) being raised; and a computer (15) connected to this tilt detector (14) and to piloted actuation device (30) for actuating the valve-slide of the proportional distributor (13); in the event of the axle (6) tilting in a manner that tends to raise the wheel (2) situated on the side opposite the arm (3), the computer (15) controls these actuation device (30) in such a way as to control the valve-slide of the proportional valve (13). The vehicle (1) is equipped with the stabilization system.

### 1. FIELD OF THE INVENTION

The present invention relates to a stabilization system for a wheeled vehicle equipped with a load-carrying arm, and to the wheeled vehicle equipped with a load-carrying arm, including this stabilization system.

This vehicle can be of any type of vehicle equipped with an arm suitable for carrying a load or intended to carry a load, this arm being capable of being placed in a position of lateral extension relative to the vehicle. This extension is such that it is likely to generate a tilting moment which could risk leading to an overturning of the vehicle, or at least to lift a wheel of the vehicle, causing instability of the vehicle along a line passing through this wheel and through the diagonally opposite wheel.

The vehicle can in particular be a sparer, that is to say a vehicle for cutting copses or mowing grass on an embankment along a traffic lane; the load carried by the arm is then the cutting or mowing tool.

A wheeled vehicle equipped with a load-carrying arm can, in certain situations, be unbalanced to the point of risking overturning, due to the load carried by the arm and the offset of this arm relative to the vehicle, and in particular when crossing a ground obstacle leading to raising a wheel of the vehicle located on the side opposite to the side on which the arm extends.

In the description below, there will be distinguished a wheel of the vehicle located on the lateral side of the vehicle opposite the lateral side of the vehicle on which the arm extends, and a wheel of the vehicle located on the same lateral side of the vehicle as that on which the arm extends; for simplification, the first cited wheel will be defined as “on the side opposite the arm” and the second cited wheel will be defined as “on the side of the arm”. It will be the same for the so-called “compensation” cylinders or jacks described below, one of these cylinders being located “opposite the arm” and the other being located “on the side of the arm”.

### 2. PRIOR ART BACKGROUND OF THE INVENTION

Existing vehicles are dedicated to performing a specific type of work and are designed accordingly, in order to best deal with the risk of overturning likely to arise on the vehicle concerned. However, this specialization means having several types of vehicles, which is of course problematic from an economic point of view, in terms of space, maintenance, etc.

This same problem of risk of overturning leads to the fact that certain existing vehicles, in addition to their specialization, have limited performance in terms of possible arm offset and/or in terms of type or weight of the loads that it is possible to mount on the arm or carry with that arm.

There is no general-purpose vehicle, the arm of which would be suitable for being used for different works, in particular for receiving different tools, with interesting performances in terms of possible arm offset and/or type or weight of the loads which it is possible to mount on the arm, and on which the problem of the risk of overturning of the vehicle could be dealt with in an adaptable manner to the type of work to be performed and the types of tools adapted to be mounted on the arm.

The present invention therefore aims to remedy this shortcoming.

It is certainly known to stabilize a vehicle by means of crutches; these crutches are however only usable in a static way, while the vehicle is stopped, and are therefore not suitable for a vehicle having to progress on a ground or a traffic lane for performing of the required work. In addition, these crutches cannot be used on possibly uneven or loose ground, as can be the case with wood log handling vehicles working in the forest.

The documents FR 1 406 770 A, U.S. Pat. Nos. 5,180,028 A and 5,639,119 A disclose various systems in accordance with the prior art, not making it possible to overcome the abovementioned shortcoming.

### 3. SUMMARY OF THE INVENTION

The stabilization system concerned is therefore intended to equip a wheeled vehicle including a load-carrying arm, the vehicle comprising a chassis, referred to hereinafter as “main chassis”, on which at least one wheel-carrying axle is mounted oscillating about a bearing; a cylinder, referred to hereinafter as “the arm cylinder”, is associated with the load-carrying arm to adjust the inclination of this arm relative to this main chassis.

According to the invention, the stabilization system comprises:

an oscillating chassis connected to said axle at two connection points located at a distance from said bearing, on either side of this bearing and symmetrically to the axis thereof; this connection of this oscillating chassis to the axle allows this chassis to oscillate with the axle; said load-carrying arm is intended to be mounted on this oscillating chassis;

two cylinders, also called jacks or actuators, referred to hereinafter as “compensation cylinders”, one of which connects a first of said connection points to said main chassis and the other connects the second of said connection points to said main chassis; a first of these compensation cylinders is located opposite the arm and the second of these compensation cylinders is located on the side of the arm;

a proportional distributor, also called directional control valve; the upper chamber of the first compensation cylinder and the lower chamber of the second compensation cylinder are connected by a same first pipe to a port located on a first side of the slide-valve, also called spool, of this distributor, while the lower chamber of the first compensation cylinder and the upper chamber of the second compensation cylinder are connected by a same second pipe to another port located on the first side of the slide-valve of this distributor; the lower chamber of the arm cylinder is connected to a port located on a second side of the distributor slide-valve, opposite to said first side, and another port of this slide-valve located on this second side is connected to a tank of fluid; the distributor slide-valve includes a first section which, in a first position of the slide-valve, puts the upper and lower chambers of the compensating cylinders in communication with the tank of fluid and puts the lower chamber of the arm cylinder in a stopping position stopping the flow of fluid; the slide-valve comprises a second section which, in a second position of the slide-valve, puts the upper chamber of the first compensation cylinder and the lower chamber of the second compensation cylinder in communication with the lower chamber of the arm cylinder and simultaneously puts the lower chamber of the first compensation cylinder and the upper chamber of the second compensation cylinder in communication with the tank of fluid; the distributor is associated with piloted actuation means making it possible to normally maintain the slide-valve in said first position, to gradually bring this slide-valve from said first position to said second position, and to gradually bring this slide-valve from said second position to said first position;

an axle tilt sensor, detecting an axle tilt in which the wheel of the vehicle opposite the arm is raised;

a calculator, also called computer, connected on the one hand to this tilt sensor and on the other hand to said piloted actuation means of the distributor slide-valve; in the event of the axle tilting in a manner that tends to raise the wheel situated on the side opposite the arm, the calculator controls these actuating means in such a way as to control the gradual passage of the slide-valve of the distributor from said first position to said second position according to the detected axle tilt.

It will be understood that the expressions “upper chamber” and “lower chamber” of one or the other of said cylinders, designate the parts of the chamber of the cylinder which are located on either side of the piston of this cylinder; the upper chamber is the one which is furthest from the ground when the vehicle is placed on the ground, and vice versa with regard to the lower chamber.

By “proportional” distributor is meant a distributor, the slide-valve of which comprises bevel machined conduits so that the displacement of the slide-valve achieves a gradual variation in the flow rate of actuating fluid of the cylinders through this slide-valve; such a distributor is well-known in itself.

In the absence of an inclination of the axle, the distributor slide-valve is held in said first position, in which the actuating fluid of the cylinders flows freely through the distributor slide-valve, so that the compensating cylinders have no action on the axle; the lower chamber of the arm cylinder is supplied by an independent source of fluid, in order to control the inclination of the arm adequately according to the work to be performed.

In the event of an inclination of the axle with respect to the main chassis, for example in the event of the crossing of a ground obstacle leading to raising the wheel situated opposite the arm, therefore situated on the side of the first compensating cylinder, the inclination sensor transmits the information on this inclination to the calculator and the calculator controls said distributor actuation means so as to gradually move the distributor slide-valve from said first position to said second position, according to the degree of inclination detected; the pressurized fluid contained in the lower chamber of the arm cylinder is then supplied under pressure, through the distributor, to the upper chamber of the first compensation cylinder and to the lower chamber of the second compensation cylinder, thereby causing these cylinders to exercise on the axle a torque tending to bring the axle to a position in which the raised wheel is brought back into contact with the ground, thus eliminating the instability of the vehicle along the diagonal going from this raised wheel to the opposite wheel located on the other axle of the vehicle; the escape of the fluid from the lower chamber of the arm cylinder leads to a retraction of the rod of this cylinder, which contributes to quickly compensating for the instability of the vehicle.

Once the ground obstacle has been crossed, the return of the axle to a non-tilting position leads the calculator to control said actuating means so as to gradually return the distributor slide-valve to said first position.

In the event of the axle tilting relative to the main chassis, for example in the event of a ground obstacle, leading to raising the wheel located on the side of the arm, therefore located on the side of the second compensation cylinder, the calculator does not does not act on the actuating means of the distributor slide-valve, so that this slide-valve remains in said first position.

The invention therefore provides a stabilization system making it possible to deal in real time with the risk of the vehicle overturning by a compensation action on the inclination of the axle; this treatment is implemented regardless of the type of work to be performed and the types of tools capable of being mounted on the arm, and thus makes the vehicle equipped with this system completely versatile.

The vehicle can be designed so that the arm which it comprises is designed to act only from the same lateral side of the vehicle. Preferably, however, the vehicle is designed so that said load-carrying arm is mounted on a pivot with a vertical pivot axis allowing this arm to be brought on one or the other of the lateral sides of the vehicle, and that, consequently, this arm is able to work on one or the other of the lateral sides of the vehicle; in that case,

the stabilization system comprises a sensor for detecting the angular position of the arm relative to the vehicle, making it possible to determine on which lateral side of the vehicle the arm is located, this sensor being connected to the calculator;

the distributor slide-valve includes a third section in which the communications between the compensation cylinders with the lower chamber of the arm cylinder and with the tank of fluid are reversed relative to the communications made possible by said second section; said second section is brought into its active position when the arm is placed on a first lateral side of the vehicle and said third section is brought into its active position when the arm is placed on a second lateral side of the vehicle, opposite to the first lateral side of the vehicle; these second and third sections thus make it possible to always put the upper chamber of the compensating jack located opposite the arm and the lower chamber of the compensating jack located on the side of the arm in communication with the lower chamber of the arm cylinder, and to simultaneously put the other chambers of these compensating cylinders in the position of escape of the fluid regardless of the lateral side of the vehicle on which the arm is located.

The same effect as above, of exercising on the axle a torque tending to tilt this axle so as to bring the raised wheel back into contact with the ground, is thus obtained regardless of the side of the vehicle on which the arm is located.

Preferably,

the vehicle is so designed that said arm is interchangeable, and/or that the load capable of being carried by this arm, for example a tool, is interchangeable with respect to the arm;

the stabilization system includes a first pressure sensor, present on said pipe connecting the arm cylinder of the arm used to the distributor, a second pressure sensor, present on said first pipe connecting the compensation cylinders to the distributor, and a third sensor pressure, present on said second pipe connecting the compensation cylinders to the distributor, these first to third sensors being connected to the calculator; and

this calculator includes a self-learning function to establish a set pressure value, necessary to stabilize the vehicle according to the type of arm mounted on the vehicle, and therefore according to the type of arm cylinder specific to this arm, or depending on the load carried by the arm.

In practice, once the arm and/or the load (in particular a tool) put in place on the vehicle, the arm is deployed to the maximum while the vehicle is flat and then is actuated so as to lift the load, which leads to pressurize the fluid of the arm cylinder and which leads one of the wheels of the vehicle to lift off the ground; the self-learning function of the calculator is then activated and the distributor is controlled by the calculator so as to gradually supply the compensation cylinders in order to bring the raised wheel back into contact with the ground; when this re-stabilization state of the vehicle on its wheels is reached, said second and third sensors detect the fluid pressure which it is necessary to supply in the compensating cylinders to obtain this state, and this specific pressure value, adapted to the specific type of arm used, and/or adapted to the mass of the load carried by the arm, is recorded by the calculator. This specific pressure value is then used as a maximum set value by the calculator to control the proportional distributor so as to carry out the axle tilt compensation adapted to the specific type of arm or to the mass of the load carried by the arm. In this case, the computer will pilot the coils of the distributor to supply the compensating cylinders with fluid in order to reach a pressure proportional to the pressure of the arm cylinder. The calculator will maintain this proportion by establishing a real time copy.

The vehicle equipped with the stabilization system thus designed is therefore able to receive various types of interchangeable arms, having arm cylinders specific to them, and/or loads having different masses, and the stabilization system is capable of self-calibrate according to the pressure that exists in the arm cylinder specific to the arm used, when the load is lifted.

The invention will be clearly understood, and other characteristics and advantages thereof will appear, with reference to the appended drawing, representing, by way of non-limiting examples, several possible embodiments of a vehicle equipped with the stabilization system concerned.

### 4. BRIEF DESCRIPTION OF THE DRAWINGS

FIG. 1 is a schematic view of a four-wheeled vehicle, from the rear of this vehicle, and of the main components of the stabilization system, according to a first embodiment, the vehicle being in a neutral position, of non-tilt compensation of the rear axle of the vehicle;

FIG. 2 is a view of the vehicle and the stabilization system similar to FIG. 1 in case of raising of the wheel opposite the arm;

FIG. 3 is a view of the vehicle and the stabilization system similar to FIG. 1 in case of raising of the wheel located on the side of the arm;

FIG. 4 is a view similar to FIG. 1 of a vehicle on which the arm can be placed on either of the lateral sides of the vehicle, and of the corresponding stabilization system, according to a second embodiment, the vehicle being shown in a situation where the wheel is raised on the side of the arm;

FIG. 5 is a view of the vehicle similar to FIG. 4, in a situation of raising of the wheel located on the side opposite the arm and while this arm is placed on a first side of the vehicle;

FIG. 6 is a view of the vehicle similar to FIG. 5, in a situation of raising of the wheel located on the side opposite the arm and while this arm is placed on a second side of the vehicle, opposite to the first side; and

FIG. 7 is a view of the vehicle similar to FIG. 4, the vehicle comprising a stabilization system according to a third embodiment.

### 5. DESCRIPTION OF THE PREFERRED EMBODIMENTS

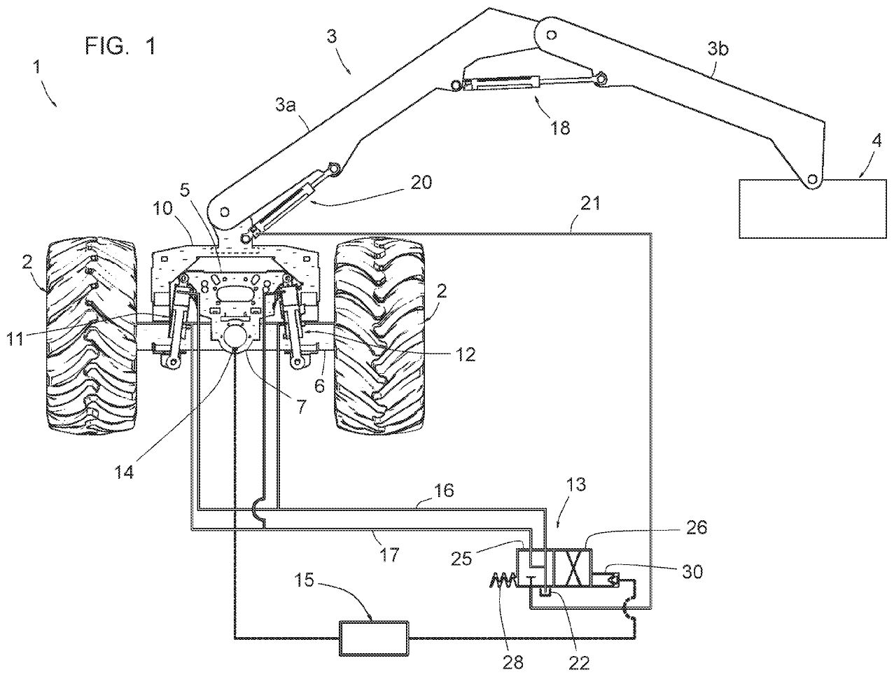

FIGS. 1 to 3 show a vehicle 1 with rear wheels 2, comprising an arm 3 capable of carrying a load 4. This load 4 can be of any type; it may in particular be a tool for cutting copses or mowing the grass present on an embankment along a traffic lane.

The vehicle 1 comprises a chassis 5, referred to hereinafter as “main chassis”, on which an axle 6 carrying the two wheels 2 is mounted oscillating about a bearing 7. This chassis 5 comprises a front axle carrying two front wheels, not shown in the figures.

The vehicle 1 is equipped with a stabilization system comprising an oscillating chassis 10, a first cylinder 11, a second cylinder 12, a proportional distributor 13, a sensor 14 for detecting the tilting of the axle 6 and a calculator 15.

The oscillating chassis 10 has, in a direction transverse to the longitudinal axis of the vehicle 1, a dimension such that it is capable of being connected to the axle 6 at two points of connection to this axle located on either side other of the bearing 7, at a distance from this bearing and situated symmetrically with respect to the axis of this bearing.

The connection of this oscillating chassis 10 to the axle 6 makes this chassis have the capability of oscillating with this axle in the event of an encounter with a ground obstacle as denoted by the reference 100 in the figures.

One of the connection points is pivotally connected to the piston rod of the first cylinder 11 and the body of this first cylinder 11 is pivotally connected to the main chassis 5; the other of these connection points is pivotally connected to the piston rod of the second cylinder 12 and the body of this second cylinder 12 is also pivotally connected to the main chassis 5. These cylinders 11, 12 are referred to hereinafter as “compensating cylinders”, in the sense that they make it possible to “compensate” for the inclination of the axle 6 in order to bring the wheel 2 opposite the arm in contact with the ground when this wheel is raised above the ground at on the occasion of crossing the ground obstacle 100, this raising resulting from the combination of this crossing, the offset of the arm 3 and the mass of the load 4.

It appears that the upper chambers and the lower chambers of the compensation cylinders 11, 12 are connected to the distributor 13, on the same first side of the slide-valve of this distributor; the upper chamber of the cylinder 11 and the lower chamber of the cylinder 12 are connected to a port of this slide-valve by a pipe 16, while the lower chamber of the cylinder 11 and the upper chamber of the cylinder 12 are connected to another port of this slide-valve, by a pipe 17.

The arm 3 includes a base pivotally mounted on an upper wall of the oscillating chassis 10; in the embodiment shown in FIGS. 1 to 3, this base pivots on a maximum sector of 90° relative to the oscillating chassis 10, on either side of a lateral median position, so that the arm 3 always remains on the same lateral side of the vehicle 1 (the right side of this vehicle as shown in these figures) or that it can be positioned in the longitudinal axis of the vehicle 1.

This arm 3 also has, in this embodiment, a boom 3a pivotally connected to said base of the arm, and a free end part 3b capable of receiving the load 4. This free end part 3b is connected pivotally to the boom 3a and is capable of being actuated relative to the latter by means of a cylinder 18.

The inclination of the boom 3a with respect to the oscillating chassis 10 is produced by means of a cylinder 20, referred to hereinafter as “arm cylinder”, the lower chamber of which is connected to the distributor 13 by a pipe 21, in a port located on a second side of the distributor slide-valve, opposite said first side. Another port of this slide-valve, on this second side is connected to a tank 22 of actuating fluid of the cylinders 11, 12.

The lower chamber of the cylinder 20 is also connected to an independent source of actuating fluid, making it possible, in combination with the cylinder 18, to deploy the arm 3.

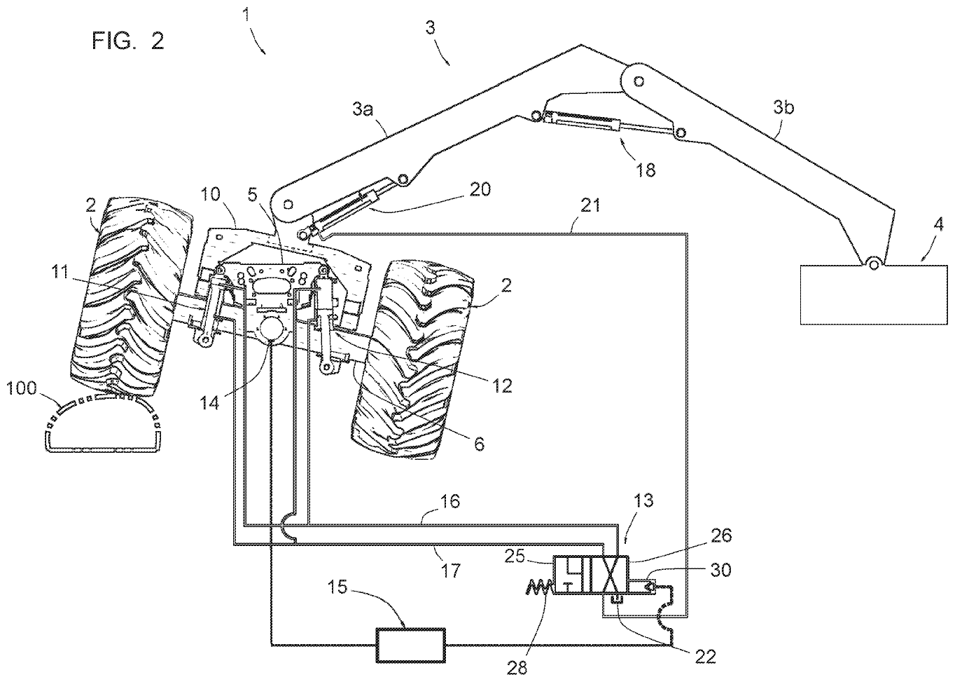

The distributor 13 is of known type, being in particular that marketed by the company Fluid System under the reference 2149-90-A. The slide-valve thereof comprises a first section 25 which, in a first position of the slide-valve shown in FIG. 1, puts the upper and lower chambers of the cylinders 11, 12 in an escape state allowing the escape of the fluid and puts the lower chamber of the arm cylinder 20 in a stopping position in which the flow of fluid is stopped; the slide-valve comprises a second section 26 which, in the second position of the slide-valve shown in FIG. 2, puts the upper chamber of the cylinder 11 and the lower chamber of the cylinder 12 in communication with the lower chamber of the cylinder 20, and simultaneously puts the lower chamber of cylinder 11 and the upper chamber of cylinder 12 in an escape state allowing the escape of the fluid therefrom.

The qualifier of “proportional” for this distributor 13 means that the slide-valve comprises bevel machined conduits such that the displacement of the slide-valve achieves a gradual variation in the flow rate of control fluid of the cylinders 11, 12 through this slide-valve.

The slide-valve of the distributor 13 is slidably biased, on the side of the section 25, by a spring 28 and, on the side of the section 26 by a proportional coil 30 connected to the calculator 15 and controlled by the latter as a function of the angle of tilt of the axle 6 detected by the sensor 14.

This qualifier of “proportional” for this coil 30 means that the coil controls the movement of the slide-valve gradually, according to the piloting instructions provided by the calculator 15, these instructions being themselves a function of the degree of inclination of the axle. 6.

The sensor 14 is also of known type; it is able to measure the pivot angle of the axle 6 relative to the bearing 7, therefore relative to the inclination of this axle.

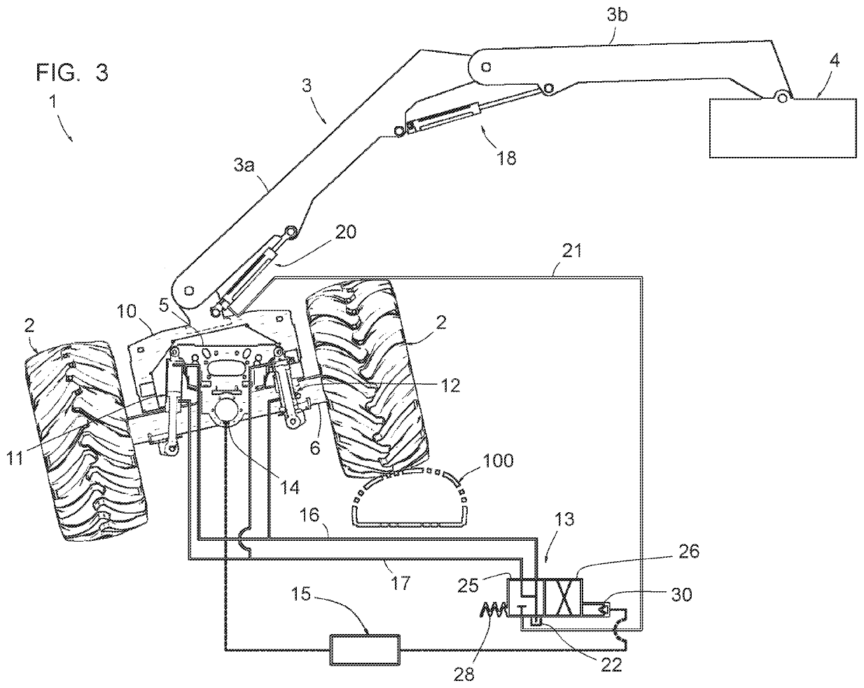

The calculator 15, which is for example the one sold under the Danfoss brand and reference MC50-010, is connected to the sensor 14 and to the coil 30; it is programmed to take into account the measurement of the inclination of the axle 6 when this inclination leads to an elevation of the wheel 2 located opposite the arm 3, which situation is shown in FIG. 2, and to act on the coil 30 so as to gradually move the slide-valve of the distributor 13 from said first position shown in FIG. 1 to towards said second position shown in FIG. 2 as a function of the inclination detected. The calculator 15 is also programmed not to take into account the measurement of the inclination of the axle 6 when this inclination of the axle leads to an elevation of the wheel 2 located on the side of the arm 3, which situation is shown in FIG. 3, so that the slide-valve 13 of the distributor, in this situation, remains in the position shown in this FIG. 3.

In practice, as can be seen in FIG. 1, in the absence of an inclination of the axle 6, the slide-valve of the distributor 13 is held in said first position by the spring 28, so that the compensating cylinders 11 and 12, in the escape position, have no action on the axle 6; the lower chamber of the arm cylinder 20 is supplied by said independent source of fluid, in order to tilt the arm 3 adequately according to the work to be carried out; this inclination of the arm means that the fluid present in the lower chamber of this cylinder 20 is under pressure.

As can be seen in FIG. 2, in the case of an inclination of the axle 6 relative to the main chassis 5, for example in the event of a ground obstacle 100, leading to raising the wheel 2 situated opposite the arm 3, therefore located on the side of the compensation cylinder 11, the sensor 14 transmits the information of this inclination to the calculator 15 and the calculator controls the coil 30 so as to move the slide-valve of the distributor 13 from said first position to said second position, depending on the degree of tilt detected; the pressurized fluid contained in the lower chamber of the arm cylinder 20 is then supplied under pressure, through the distributor 13, to the upper chamber of the cylinder 11 and to the lower chamber of the cylinder 12, thereby causing these cylinders to exert on the axle 6 a torque tending to compensate for the inclination of the axle 6 in order to bring the wheel 2 back into contact with the ground, and thus to suppress the instability of the vehicle 1 along the diagonal going from this wheel to the front wheel located on the opposite side of the vehicle, and therefore simultaneously balancing the oscillating chassis 10 relative to the main chassis 5; the escape of the fluid from the lower chamber of the arm cylinder 20 leads to a retraction of the rod of this cylinder 20, if necessary, contributing to the rapid position recovery of the oscillating chassis 10 relative to the chassis 5.

Once the ground obstacle 100 has been crossed, the return of the axle 6 to a non-tilting position leads the calculator 15 to control the coil 30 so as to cease to act on the slide-valve against the spring 28, allowing this spring 28 to return the slide-valve of the distributor 13 to said first position.

As can be seen in FIG. 3, in the event of the axle tilting 6 relative to the main chassis 5, for example in the event of a ground obstacle 100, leading to raising the wheel 2 situated on the side of the arm 3, therefore situated on the side of the cylinder 12, the calculator 15 does not act on the coil 30, so that the distributor valve 13 remains in said first position.

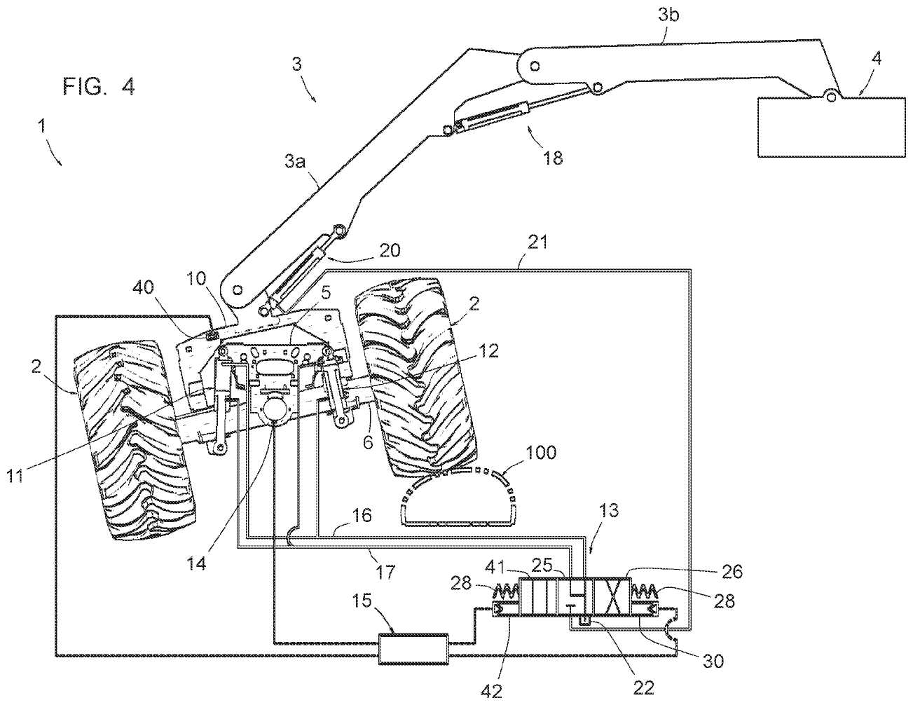

FIG. 4 represents a stabilization system according to a second embodiment, in which most of the elements already described are found in identical or similar manner. For simplicity, these elements already described which are found in this second embodiment are designated by the same reference numerals and are not described again.

In this case, the arm 3 is pivotable on a sector such that it can be brought to one or the other of the lateral sides of the vehicle 1.

The stabilization system then comprises a sensor 40 connected to the calculator 15, for detecting the angular position of the arm 3 relative to the vehicle 1, thus making it possible to determine on which lateral side of the vehicle 1 the arm 3 is located.

The slide-valve of the distributor 13 comprises a third section 41, located, in relation to section 25, on the side of the valve-slide opposite to that on which section 26 is located, allowing connections of the compensating cylinders 11, 12 with the lower chamber of the arm cylinder 20 and with the tank of fluid 22 which are reversed with respect to the connections made possible by the second section 26.

In addition, in this second embodiment, the valve-slide of the distributor 13 is associated with a proportional coil 42 identical to coil 30, located on the side of the valve-slide opposite to that on which this coil 30 acts, and acting in an antagonistic manner to the latter. It is also associated with two springs 28, one on each side of the valve-slide of the distributor 13, so as to return this valve-slide to its central position if no coil 30, 42 is energized; the distributor 13 can thus be piloted by the computer 15 between the three possible positions of the valve-slide of the distributor 13.

In this FIG. 4, the situation shown is that in which the wheel 2 located on the side of the arm 3 which is raised; in this situation, as already described, the section 25 of the slide-valve of the distributor 13 is active.

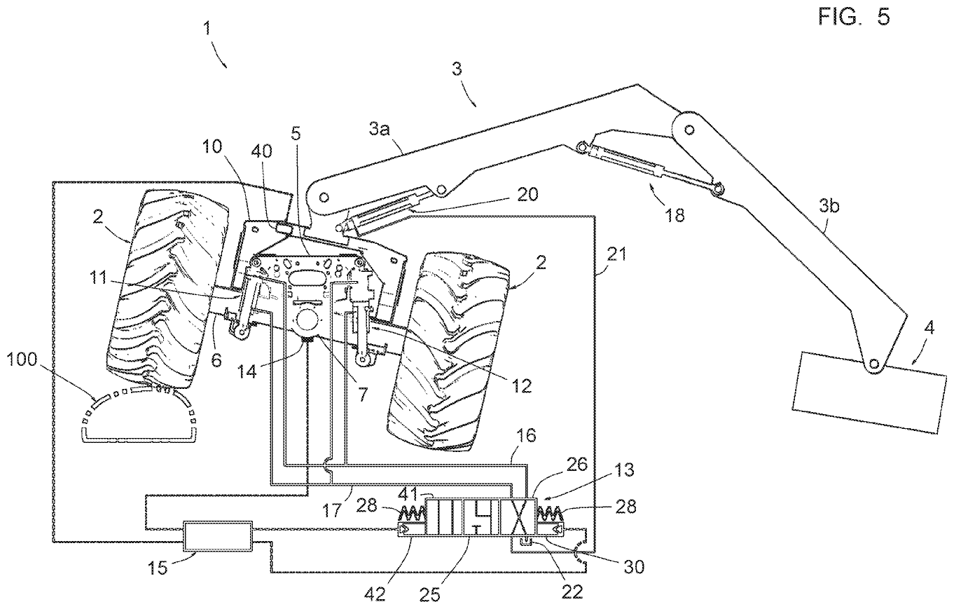

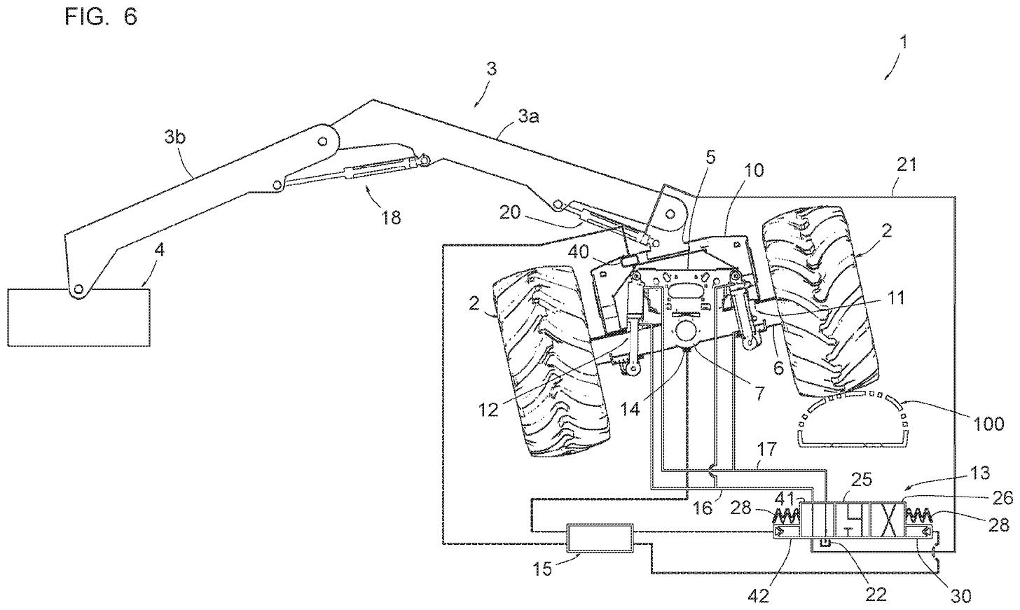

As can be seen in FIG. 5, section 26 is placed in the active position when the arm 3 is located on a first lateral side of vehicle 1 (the right side of vehicle 1 as shown in FIG. 5); FIG. 6 shows that the third section 41 is in the active position when the arm 3 is on the second lateral side of vehicle 1 (to the left of the vehicle as shown in FIG. 6), opposite the first side. These sections 26 and 41 therefore allow to always put the upper chamber of the compensation cylinder located on the side of the elevated wheel 2 opposite to the arm 3, and the lower chamber of the compensation cylinder located on the side of the arm 3, in communication with the lower chamber of the arm cylinder 20 and to simultaneously put the other chambers of these compensation cylinders 11, 12 in the exhaust position, regardless of the lateral position of the arm 3 in relation to the vehicle.

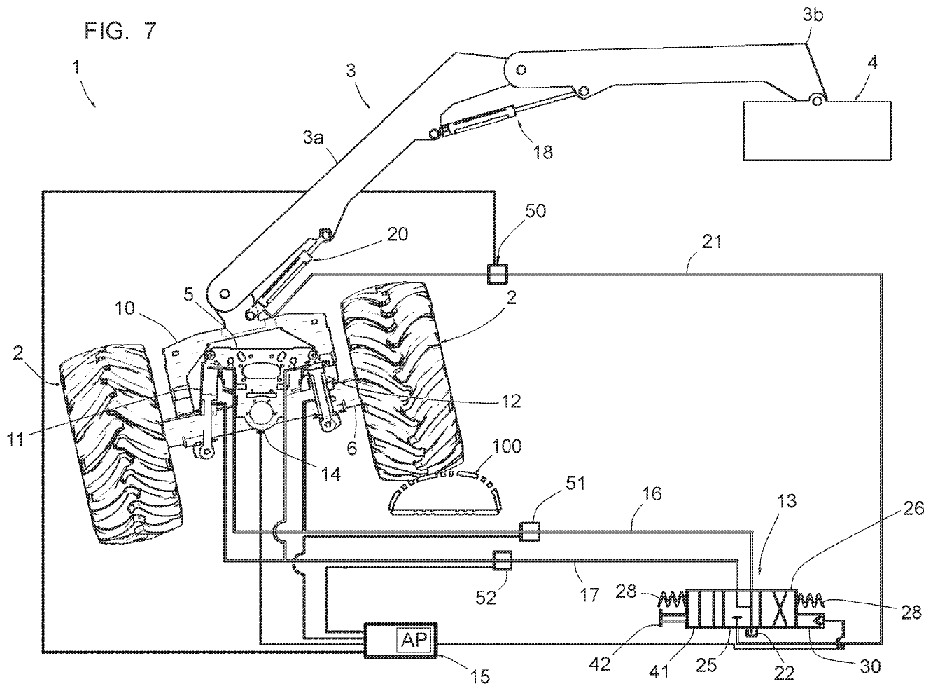

FIG. 7 represents a stabilization system according to another embodiment, in which most of the elements already described are also found in an identical or similar manner and are designated by the same reference numbers as above.

In this case, the vehicle 1 is designed so that the arm 3 is interchangeable, so that the vehicle can be adapted to different types of work, the interchange being done by dismounting an arm 3 relative to the pivoting base and mounting of another arm 3. This interchange means that the arm cylinder 20 associated with each arm is different in terms of chamber volume and working pressure.

Alternatively or cumulatively, the vehicle 1 is designed so that the load 4 is interchangeable with respect to the arm 3, for example a tool of a first type being interchangeable with one or more tools of another type, having no not the same mass as the other tools, or the load may vary during the use of the vehicle, for example when transporting logs in the forest.

As shown in FIG. 7, the stabilization system then comprises a first pressure sensor 50, present on the pipe 21 connecting the arm cylinder 20 of the arm 3 used to the distributor 13, a second pressure sensor 51, present on the pipe 16 connecting the compensation cylinders 11, 12 to the distributor 13, and a third pressure sensor 52, present on the pipe 17 connecting the compensation cylinders 11, 12 to the distributor 13, these various sensors being connected to the calculator 15.

These sensors are e.g. from Danfoss, reference no. MBS120.

The calculator 15 includes a self-learning function AP making it possible to establish a set pressure value, necessary to stabilize the vehicle depending on the type of arm 3 mounted on the vehicle, and therefore depending on the type of arm cylinder 20 which equips this arm, or depending on the load 4 carried by the arm.

In practice, once the arm 3 and/or the load 4 put in place on the vehicle 1, the arm 3 is deployed as far as possible while the vehicle 1 is flat and then is actuated so as to lift the load 4, which leads to put the fluid of the arm cylinder 20 under pressure and which leads one of the wheels 2 of the vehicle to rise from the ground; the self-learning function AP of the calculator 15 is then activated and the distributor 13 is controlled by the calculator so as to gradually supply the compensation cylinders 11, 12 in order to bring the raised wheel 2 back into contact with the ground; when this state of re-stabilization of the vehicle 1 on its wheels 2 is reached, said second and third sensors 51, 52 detect the fluid pressure which it is necessary to supply in the compensation cylinders 11, 12 in order to obtain this state, and this specific pressure value, adapted to the specific type of arm 3 used, and/or adapted to the mass of the load 4 carried by the arm, is recorded by the calculator 15. This specific pressure value is then used as a maximum set value by the calculator 15 for controlling the proportional distributor 13 so as to carry out the compensation of the inclination of the axle 6 adapted to the specific type of arm 3 or to the mass of the load 4 carried by the arm 3. The computer 15 will control the coils 30, 42 of the distributor to supply the compensating cylinders 11, 12 in order to reach a pressure proportional to the pressure of the arm cylinder 20. The computer 15 will maintain this proportion by establishing a real time copy.

The vehicle 1 equipped with the stabilization system thus designed is therefore able to receive various types of interchangeable arms 3, having arm cylinders 20 specific to them, and/or loads 4 having different masses, and the stabilization system is capable to self-calibrate according to the pressure that exists in the arm cylinder 20 of the arm 3 used, when the load 4 is raised.

1. A stabilization system for a wheeled vehicle equipped with a load-carrying arm, the vehicle comprising a main chassis, on which at least one axle carrying wheels is mounted oscillating about a bearing; an arm cylinder associated with a load-carrying arm to adjust the inclination of the arm cylinder relative to the main chassis;
wherein the system comprises:
an oscillating chassis connected to said axle at two connection points located at a distance from said bearing, on either side of the bearing and symmetrically to the axis thereof; the connection of the oscillating chassis to the axle allows the chassis to oscillate with the axle; said load-carrying arm is intended to be mounted on the oscillating chassis;
a first compensation cylinder connected to a first of said connection points to said main chassis and a second compensation cylinder connected to the second of said connection points to said main chassis; a first compensation cylinder is located opposite the arm and the second compensation cylinder is located on the side of the arm;
a proportional distributor; an upper chamber of the first compensation cylinder and a lower chamber of the second compensation cylinder are connected by a same first pipe to a port located on a first side of a slide-valve of the distributor, while the lower chamber of the first compensation cylinder and the upper chamber of the second compensation cylinder are connected by a same second pipe to another port located on the first side of the slide-valve of this distributor; the lower chamber of the arm cylinder is connected to a port located on a second side of the distributor slide-valve, opposite to said first side, and another port of the slide-valve located on the second side is connected to a tank of fluid; the distributor slide-valve includes a first section which, in a first position of the slide-valve, puts the upper and lower chambers of the compensating cylinders in communication with the tank of fluid and puts the lower chamber the arm cylinder in a stopping position stopping the flow of fluid; the slide-valve comprises a second section which, in a second position of the slide-valve, puts the upper chamber of the first compensation cylinder and the lower chamber of the second compensation cylinder in communication with the lower chamber of the arm cylinder and simultaneously puts the lower chamber of the first compensation cylinder and the upper chamber of the second compensation cylinder in communication with the tank of fluid; the distributor is associated with piloted actuating device making it possible to normally maintain the slide-valve in said first position, to gradually bring the slide-valve from said first position to said second position, and to gradually bring the slide-valve from said second position to said first position;
an axle tilt sensor detecting an inclination of the axle in which the wheel of the vehicle opposite the arm is raised; and
a calculator connected on the one hand to this tilt sensor and on the other hand to said piloted actuation means of the distributor slide-valve; in the event of the axle tilting in a manner that tends to raise the wheel situated on the side opposite the arm, the calculator controls these actuating device in such a way as to control the gradual passage of the slide-valve of the distributor from said first position to said second position according to the detected inclination of the axle.

2. The stabilization system of claim 1, wherein the system is intended to equip a vehicle designed such that the arm that comprises the vehicle is mounted on a pivot with a vertical pivot axis allowing this arm to be brought on one or the other of the lateral sides of the vehicle, wherein:
the stabilization system comprises a sensor for detecting the angular position of the arm relative to the vehicle, making possible to determine on which lateral side of the vehicle is the arm is located, the sensor being connected to the calculator;
the distributor slide-valve includes a third section, in which the communications between the compensation cylinders with the lower chamber of the arm cylinder and with the tank of fluid are reversed relative to the communications made possible by said second section; said second section is brought into an active position when the arm is placed on a first lateral side of the vehicle and said third section is brought into its active position when the arm is placed on a second lateral side of the vehicle, opposite to the first lateral side of the vehicle; the second and third sections thus make 4: possible to always put the upper chamber of the compensating jack located opposite the arm and the lower chamber of the compensating jack located on the side of the arm in communication with the lower chamber of the arm cylinder, and to simultaneously put the other chambers of the compensating cylinders in the position of escape of the fluid regardless of the lateral side of the vehicle on which the arm is located.

3. The stabilization system of claim 1, wherein the system is intended to equip a vehicle designed so that the arm is interchangeable, and/or that the load capable of being carried by the arm is interchangeable with respect to the arm,
wherein:
the stabilization system includes a first pressure sensor, present on said pipe connecting the arm cylinder of the arm used to the distributor, a second pressure sensor, present on said first pipe connecting the compensation cylinders to the distributor, and a third sensor pressure, present on said second pipe connecting the compensation cylinders to the distributor, these first to third sensors being connected to the calculator; and
the calculator includes a self-learning function to establish a set pressure value, necessary to stabilize the vehicle according to the type of arms mounted on the vehicle, and therefore according to the type of arm cylinder specific to the arm, or depending on the load carried by the arm.

4. A vehicle (1) with wheels (2) including a load-bearing arm (3), the vehicle (1) comprising: a main chassis, on which at least one axle (6) bearing the wheels (2) is mounted so as to oscillate about a bearing (7), and including a arm cylinder, associated with the load-bearing arm (3) in order to adjust the inclination of the load-bearing arm (3) with respect to the main chassis (5);
wherein the vehicle further includes the stabilization system according to claim 1.
